(19) United States
(12) Patent Application Publication
(10) Pub. No.: US 2009/0051266 A1
(43) Pub. Date: Feb. 26, 2009

(54) Light-Emitting Device

(76) Inventors: Hisaya Takahashi, Kanagawa (JP); Atsushi Namba, Tokyo (JP); Miyuki Kobayashi, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/886,713

(22) PCT Filed: Apr. 4, 2006
(86) PCT No.: PCT/JP2006/307110

§ 371 Date: Sep. 20, 2007

(30) Foreign Application Priority Data
Apr. 5, 2005 (JP) 2005-108626

(51) Int. Cl. H01J 63/02

(52) U.S. Cl. 313/495

(57) ABSTRACT

An electron emitting source 6 is covered with a cathode mask 20 whose opening areas are substantially the same as those in a grid electrode 10, so that the areas for which the electrons are emitted from the electron emitting source 6 can substantially be the same as the opening areas in the grid electrode 10. Thus, substantially all the electrons emitted from these areas can be ensured to pass through opening portions 11 in the grid electrode 10 so as to be effective electrons that can contribute to light emission. In this way, power loss at the grid electrode 10 can be reduced. At the same time, harmful metallic sputtering caused at the grid electrode 10 toward a cathode electrode 5 can be reliably prevented, whereby damages on the cathode electrode can be avoided.

### TECHNICAL FIELD

The present invention relates to a light-emitting device for bringing a fluorescent material into a state of excitation and light emission by electrons that have been field-emitted from an electron emitting source.

### BACKGROUND ART

Alternative to the conventional light-emitting devices, such as incandescent lamps or fluorescent lamps, cold-cathode electrode field-emission type light-emitting devices are under development lately. This type of light-emitting device enables excitation and light emission of a fluorescent material by allowing field emission of electrons in a vacuum from an electron emitting source and by having the electrons impinged at high speed on the fluorescent material. This type of light-emitting device is expected to be applied to field emission lamps (FELs) or field emission displays (FEDs).

This type of light-emitting device achieves fluorescent light emission by drawing electrons for a cathode electrode with the use of a grid electrode imparted with positive potential and by allowing the electrons to impinge on a fluorescent plate electrode imparted with positive high voltage. In this case, when the grid electrode is arranged opposed to the cathode electrode whose plane surface is provided with a film that serves as a cold-cathode electrode electron source, part of the electrons that have been drawn by the electric field between the cathode electrode and the grid electrode can reach the fluorescent plate electrode but the remnant of the electrons plunges into the grid electrode, problematically wasting the electric power.

To cope with the problem mentioned above, Japanese Patent Laid-Open No. 2004-207066 (Patent Document 1) discloses a technique associated with the FELs. Specifically, Patent Document 1 discloses a technique in which a substantially flat plate, which is substantially parallel to the surface of a cathode electrode, is arranged with holes provided therein and with an end of each hole being projected to the side of the cathode electrode to provide a structure as a grid electrode. The technique disclosed in Patent Document 1 can raise the electric field at the end of the hole higher than the electric field in the substantially flat plate area to suppress the electrons from ineffectively plunging into the grid electrode from the cathode electrode.

Similarly, Japanese Patent Laid-Open No. 2004-220896 (Patent Document 2) discloses a technique associated with the FELs, in which a semicylindrical grid electrode partially provided with openings encloses a rectangular parallelepiped cathode electrode with a gap being provided therebetween. The technique disclosed in Patent Document 2 can suppress the positive ions, which are beaten out by the electrons that have plunged into the fluorescent plate electrode, from plunging into the cathode electrode to prevent discharge breakdown. Thus, calculating and designing, in advance, of the locus of electron emission and then providing the openings can enhance the probability for the emitted electrons to plunge into the fluorescent material, passing through the openings without plunging into the grid electrode.

As to the FEDs or the like, a cathode electrode and a grid electrode are arranged significantly close to each other utilizing the photolithography technique, for example, to provide a design that can prevent absorption of the electrons by the grid electrode. FIG. 3 shows a typical structure of a cathode electrode in the FED, in which an electron emitting source 101 and an insulating layer 102 are deposited on a cathode electrode 100, and a gate electrode (grid electrode) 103 made of a metal material is deposited on the insulating layer 102. A thickness A of the insulating layer 102 is 20 μm or less, for example, and an opening dimension B of the gate electrode 103 is several to several tens of μm, for example.

However, in the technique disclosed in Patent Document 1, it is not necessarily easy to keep the accuracy for processing the end of each hole of the grid electrode, which may become a factor for increasing the cost. In the technique disclosed in Patent Document 2 as well, somewhat special shape of the grid electrode is disadvantageous as far as the processing accuracy and the manufacturing processes are concerned. In addition, it is not necessarily easy to contrive a design for the openings of the grid electrode, which design is able to uniform the probability for the emitted electrons to plunge into the fluorescent material.

Further, the photolithography technique used for the FEDs or the like involves high costs for the facilities and for the manufacturing processes, which hardly matches the manufacturing processes of the FELs whose product prices are low. In addition, arranging the cathode electrode and the gate electrode significantly close to each other (100 μm or less) can involve a drawback of easily causing metallic sputtering when gas ions in high-speed movement in a vacuum vessel impinge on the gate electrode, and thus can lead to damaging the cathode electrode.

The present invention has been made in light of the circumstances described above, and has as its object to provide a light-emitting device, which is able to reduce the electric power loss of a grid electrode with a simple configuration and reliably prevent the occurrence of harmful metallic sputtering.

### DISCLOSURE OF INVENTION

### Means for Solving the Problem

In order to solve the above object, the present invention provides a light-emitting device at least including in a vacuum a cathode electrode having an electron emitting source, a grid electrode having a plurality of opening portions, and a fluorescent plate electrode having a fluorescent material, wherein the device further includes a cathode mask having substantially the same opening portions as those in the grid electrode and masking the electron emitting source of the cathode electrode.

An opening dimension AG of each of the opening portions in the grid electrode with respect to an opening dimension AM of each of the opening portions in the cathode mask may preferably range as expressed by the following inequality:

AM−0.2 mm≦AG≦AM+0.5 mm.

In particular, when the opening dimension AM of each of the opening portions in the cathode mask ranges from 0.5 to 5 mm, the above range of the opening dimension AG should preferably be satisfied. Also, a distance S between the cathode mask and the grid electrode may preferably range from 0.5 to 5 mm.

### BRIEF DESCRIPTION OF THE DRAWINGS

FIG. 1 is a diagram showing a basic configuration of a light-emitting device;

FIG. 2 is an explanatory view showing a relation between a grid electrode and a cathode mask; and

FIG. 3 is an explanatory view showing a typical structure of a cathode electrode in a conventional field emission display device.

### BEST MODE FOR CARRYING OUT THE INVENTION

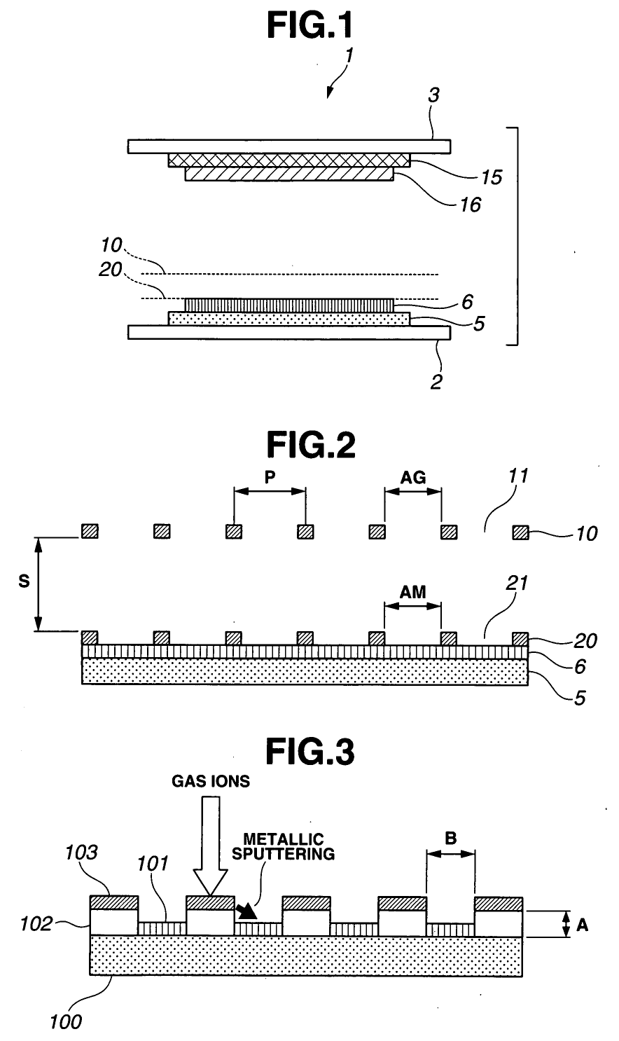

Hereinafter is described an embodiment of the present invention with reference to the drawings. FIGS. 1 and 2 show an embodiment of the present invention. FIG. 1 is a diagram showing a basic configuration of a light-emitting device, and FIG. 2 is an explanatory view showing a relation between a grid electrode and a cathode mask.

As shown in FIG. 1, a light-emitting device 1 according to the present embodiment is a light-emitting device used, for example, as a planar field emission lamp. The light-emitting device 1 is provided with glass base members 2 and 3, which are arranged to face with each other with a predetermined distance therebetween and with its interior being kept vacuum. In the vacuum interior, a cathode electrode 5, a grid electrode 10 and a fluorescent plate electrode 15 are arranged to provide a basic triode structure. Further, the device is provided with a cathode mask 20, which is arranged on the cathode electrode 5.

The cathode electrode 5 made of a conductive material is provided on the glass base member 2 that serves as a base. The cathode electrode 5 is formed, for example, by depositing metal, such as aluminum and nickel, on the glass base member 2 using vapor deposition, sputtering or the like, or by applying a silver paste material to the glass base member 2, followed by drying and baking. A surface of the cathode electrode 5 is applied with a film of an emitter material, such as a carbon nanotube film, a carbon nanowall film, a Spindt-type microcone film and a metal oxide whisker film, to form an electron emitting source 6.

The grid electrode 10 is arranged opposed to the cathode electrode 5. The potential difference between the grid electrode 10 and the cathode electrode 5 is controlled, so that an electric filed is applied to the electron emitting source 6 and electrons are emitted. A number of fine openings are formed in the grid electrode 10 to pass the electrons emitted from the electron emitting source 6. The grid electrode 10 is made up of an electrically conductive thin plate, such as a stainless member, a nickel member and an amber member, in which the multiple openings each having a circular or rectangular shape, for example, are formed using etching, punching or the like.

The fluorescent plate electrode 15 is made up of a transparent conductive film (e.g., ITO film), which is arranged on a rear surface of the glass base member 3 that serves as a light-emitting plane. A fluorescent material 16, which is excited for light emission by the electrons emitted from the electron emitting source 6, is applied to a surface of the fluorescent plate electrode 15 facing the grid electrode 10 (cathode electrode 5). The fluorescent material 16, which is a material such as of a zinc oxide system, is formed into a film on the fluorescent plate electrode 15 by, for example, an ink jet, photography, precipitation or electrodeposition process.

In such a triode structure, the electrons that have been field-emitted into the vacuum from the electron emitting source 6 are accelerated toward the fluorescent plate electrode 15. Only those electrons which have passed through the openings of the grid electrode 10 impinge on the fluorescent material 16 to emit light. A part of the electrons, however, is absorbed by a non-opening surface of the grid electrode 10 and turn to ineffective electrons, causing power loss. The cathode mask 20 of the present invention is to reduce such power loss of the grid electrode 10 caused by the ineffective electrons. The cathode mask 20 is formed as a member having substantially the same shape as that of the grid electrode 10 and is ensured to cover the electron emitting source 6, as shown in FIG. 2, being provided with opening portions 21 each having substantially the same shapes (similar shapes) as those of opening portions 11 in the grid electrode 10.

Specifically, the electron emitting source 6 is covered by the cathode mask 20 having opening areas which are substantially the same as those in the grid electrode 10, so that the areas for which the electrons are emitted from the electron emitting source 6 may substantially be the same as the opening areas in the grid electrode 10. Thus, substantially all the electrons emitted through these areas can be ensured to pass the opening portions 11 of the grid electrode 10 and to serve as effective electrons that can contribute to light emission. In this way, power loss at the grid electrode 10 can be reduced and thus a lossless gate can be realized.

In order to effectively realize a lossless gate, it is necessary to appropriately determine a relation between a distance from the grid electrode 10 to the cathode mask 20, which face with each other, and a diameter of each opening. The distance S between the grid electrode 10 and the cathode mask 20 is determined so as to be equal to or more than a prescribed minimum value. The minimum value of the distance has the potential to prevent harmful metallic sputtering which may occur from the grid electrode 10 toward the cathode electrode 5. At the same time, the minimum value of the distance is provided for suppressing the electrons emitted from the electron emitting source 6 from being drastically reduced, being caused by too short a distance between the grid electrode 10 and the cathode mask 20 to effectively produce the electric field. Thus, the minimum value of the distance is determined to satisfy S≧0.5 mm, for example.

Reference is now made to the opening portions 11 in the grid electrode 10 and the opening portions 21 in the cathode mask 20. When an opening dimension for each of the opening portions 11 and an opening portion for each of the opening portions 21 are AG and AM, respectively, the opening dimension AG of each of the opening portions 11 in the grid electrode 10 with respect to the opening dimension AM of each of the opening portions 21 in the cathode mask 20 may preferably fall within a range that is determined by taking into account, for example, of the field intensity required for the light emission of the fluorescent material 16 and the alignment error between the grid electrode 10 and the cathode mask 20.

The opening dimension refers to a dimension at a position where the opening portions 11 and 21, which are similar to each other, face with each other. In particular, as to circular holes, the opening dimension refers to a diameter (or radius) of each circle, and as to rectangular opening portions, the opening dimension refers to a distance between the long sides of each rectangle or a distance between the short sides of each rectangle. The same logic applies to the opening portions having other shapes.

For example, when the thickness of the entire panel of the light-emitting device 1 is 5 mm or less and the opening dimension AM of each of the opening portions 21 in the cathode mask 20 ranges from 0.5 mm to 5 mm, the distance S between the grid electrode 10 and the cathode mask 20 may preferably satisfy the conditions expressed by the following formula (1). Also, the opening dimension AG of each of the opening portions 11 in the grid electrode 10 with respect to the opening dimension AM of each of the opening portions 21 in the cathode mask 20 may preferably satisfy the conditions expressed by the following formula (2).

0.5≦S<5 (1)

AM−0.2 mm≦AG≦AM+0.5 mm (2)

It should be appreciated that an array pitch P of the opening portions 11 (21) basically relies on the process capability of manufacture. Thus, the array pitch P may, for example, be P≧AG+d (d: thickness of a member to be processed).

### EMBODIMENT

The light-emitting device 1 is a planar field emission lamp with a panel thickness of 5 mm, in which the opening portions 21 in the cathode mask 20 and the opening portions 11 in the grid electrode 10 are each formed to have circular holes. The distance S between the grid electrode 10 and the cathode mask 20, and the hole diameters AG and AM of the opening portions 11 and 21, respectively, are set at the following dimensions. The pitch P for both of the grid electrode 10 and the cathode mask 20 is 2.4 mm with the thickness d for the both being 0.2 mm.

S=1.0 mm

AG=2.2 mm

AM=2.0 mm

It has been confirmed that the light-emitting device 1 formed based on the above specification can allow substantially all the electrons emitted from the electron emitting source 6 to pass through the opening portions 11 in the grid electrode 10 and reach the fluorescent material 16. Also, in spite of the conventional simple configuration with an addition of only the cathode mask 20 to the triode structure, the useless power consumption at the grid electrode 10 can be effectively prevented. Moreover, the appropriate separation of the grid electrode 10 from the cathode mask 20 can prevent the harmful metallic sputtering from occurring, and can also prevent the gate voltage applied to the grid electrode 10 from becoming large more than necessary.

1. A light-emitting device at least comprising in a vacuum a cathode electrode having an electron emitting source, a grid electrode having a plurality of opening portions and a fluorescent plate electrode having a fluorescent material, wherein:
the device further comprises a cathode mask having substantially the same opening portions as those in the grid electrode and masking the electron emitting source of the cathode electrode.

2. The light-emitting device according to claim 1, wherein an opening dimension AG of each of the opening portions in the grid electrode with respect to an opening dimension AM of each of the opening portions in the cathode mask falls within a range of AM−0.2 mm≦AG≦AM+0.5 mm.

3. The light-emitting device according to claim 1, wherein the opening dimension AM of each of the opening portions in the cathode mask falls within a range of from 0.5 to 5 mm.

4. The light-emitting device according to claim 2, wherein the opening dimension AM of each of the opening portions in the cathode mask falls within a range of from 0.5 to 5 mm.

5. The light-emitting device according to claim 1, wherein a distance S between the cathode mask and the grid electrode falls within a range of from 0.5 to 5 mm.

6. The light-emitting device according to claim 2, wherein the distance S between the cathode mask and the grid electrode falls within a range of from 0.5 to 5 mm.

7. The light-emitting device according to claim 3, wherein the distance S between the cathode mask and the grid electrode falls within a range of from 0.5 to 5 mm.

8. The light-emitting device according to claim 4, wherein the distance S between the cathode mask and the grid electrode falls within a range of from 0.5 to 5 mm.
